(19) United States
(12) Patent Application Publication
(10) Pub. No.: US 2010/0297943 A1
(43) Pub. Date: Nov. 25, 2010

(54) WIRELESS VIDEO HUB

(76) Inventors: Jonathan KAPLAN, San Francisco, CA (US); Ariel Braunstein, San Francisco, CA (US); John Furlan, Belmont, CA (US)

Correspondence Address: PATTERSON & SHERIDAN, LLP/CISC, 3040 POST OAK BLVD., SUITE 1500, HOUSTON, TX, 77056-6582, US

(21) Appl. No.: 12/759,588

(22) Filed: Apr. 13, 2010

Related U.S. Application Data
(60) Provisional application No. 61/179,607, filed on May 19, 2009.

(51) Int. Cl. H04B 7/00

(52) U.S. Cl. 455/41.2

(57) ABSTRACT

A method for transmitting data from a digital device to a computing device. The method includes determining that a physical location of a digital device is within a predetermined range of a communications hub that is less than a maximum operable range of the communications hub, receiving first video data from the digital device in accordance with a first communications protocol, and transmitting second video data to a computing device in accordance with a second communications protocol.

### CROSS-REFERENCE TO RELATED APPLICATIONS

This application claims benefit of U.S. provisional patent application Ser. No. 61/179,607 filed on May 19, 2009, which is hereby incorporated herein by reference.

### BACKGROUND OF THE INVENTION

Wireless devices and wireless communication networks are currently in widespread use. For instance, many homes and small businesses include a wireless local area network (WLAN) that allows two or more devices to communicate information wirelessly throughout the WLAN. Wireless communication networks may include a wireless router that prioritizes information and serves as an access point to connect to the Internet through a service provider. Wireless networks may also include local wireless hubs that communicate with the wireless router to transmit and receive information, for example, to and from the Internet. Additionally, the local wireless hub is configured to forward information to other wireless devices in the wireless communication network.

Many electronic devices have limited memory for storing data, resulting in the user either uploading stored data to a computer or deleting data to make storage space available for new data. For example, a digital camera can capture a limited number of digital photos and/or videos depending on the size of the memory, typically provided in the form of a flash memory card. To make space available for new images and/or videos, the user can erase the stored data, upload the stored data to another device (e.g., a computer), install another memory card, install a larger memory card, or the like. Uploading the digital photos and/or videos from the digital camera to another device (e.g., a computer) is typically performed by connecting a data port on the digital camera to a data port on the other device using a cable, for example, a USB cable. Uploading the digital photos and/or videos may also be performed by removing the memory card from the digital camera arid attaching the memory card to an appropriate port on the other device. Both of these techniques require attachment or removal of various cables or cards, resulting in inconvenience to the user.

As the foregoing illustrates, there is a need in the art for an improved technique for communicating information between digital devices.

### SUMMARY

According to embodiments of the present invention, techniques related to digital video systems are provided. More particularly, embodiments of the present invention relate to a digital video camera including a wireless communications device. Merely by way of example, embodiments of the present invention are applied to a wireless video hub that is configured to communicate with the digital video device using a wireless protocol. However, it would be recognized that embodiments of the invention have a much broader range of applicability.

According to an embodiment of the present invention, a wireless communications hub is provided. The wireless communications hub includes a first wireless communications module configured to receive first video data according to a first communication protocol. The wireless communications hub also includes a second wireless communications module configured to transmit second video data to a server according to a second communication protocol different from the first communication protocol.

According to another embodiment of the present invention, a communications system is provided. The communications system includes a digital recording device including an image sensor, an audio sensor, a display screen, and a battery. The digital recording device also includes a first communications module configured to transmit and receive data according to a first communication protocol and an antenna coupled to the first communications module. The communications system also includes a wireless communications hub including a second communications module configured to receive data according to the first communication protocol, and a second antenna coupled to the second communications module. The wireless communications hub also includes a third communications module configured to receive data according to a second communication protocol different from the first communication protocol and a third antenna coupled to the third communications module.

According to an alternative embodiment of the present invention, a wireless communications hub is provided. The wireless communications hub includes a first antenna and a processor configured to determine that a physical location of the wireless device is within a predetermined range of the wireless communications hub. The wireless communications hub also includes a first communications module coupled to the first antenna. The first communications module is configured to receive video data from a wireless video device. The wireless communications hub further includes a second antenna and a second communications module coupled to the second antenna and configured to transmit the video data to a router using the second antenna.

According to a yet another embodiment of the present invention, a method of operating a wireless communications hub is provided. The method includes determining that a physical location of a digital recording device is within a predetermined range of the wireless communications hub and receiving first video data at the wireless communications hub. The video data is transmitted from the digital recording device to the wireless communications hub in accordance with a first wireless communications protocol. The method also includes transmitting second video data from the wireless communications hub to a server in accordance with a second wireless communications protocol.

According to another embodiment of the present invention, a method of operating a digital recording device is provided. The method includes providing video data at the digital recording device and receiving, at the digital recording device, a signal from a wireless communications hub. The signal is associated with a determination that a physical location of the digital recording device is within a predetermined range of the wireless communications hub. The method also includes transmitting the video data to the wireless communications hub in response to receiving the signal.

Many benefits are achieved by way of embodiments of the present invention over conventional techniques. For example, embodiments of the present invention provide a system characterized by virtually unlimited storage for the digital video device. Uploading video data from the digital recording device to a computer or server is performed automatically in some embodiments once the user places the digital recording device within range of the wireless communications hub, thereby triggering the automatic uploading of the video data. In this example, the wireless flow of data from the digital recording device enables clearing of its memory, making storage space available for new images and video clips.

Moreover, embodiments of the present invention provide the benefit of reduced manufacturing costs in comparison with some wireless communications techniques (e.g., 802.11-based or cellular communications). Embodiments establish a communications link using a wireless protocol that is characterized by a low power usage and an acceptable range, reducing the cost of system components including the microprocessor. A key benefit provided by embodiments of the present invention is low power operation. In contrast with conventional wireless systems in which high power operation make real-time transfer of video footage impractical because of rapid draining of camcorder batteries, embodiments of the present invention allow a user to record normally and upload video in the background as though the video footage was being stored locally on the camcorder. These and other embodiments of the invention, along with many of its advantages and features, are described in more detail in conjunction with the text below and the attached figures.

### BRIEF DESCRIPTION OF THE DRAWINGS

FIG. 1 is a simplified block diagram of an exemplary wireless hub system having a wireless communications hub in communication with a digital recording device, according to an embodiment of the present invention;

FIG. 2 is a simplified schematic block diagram of an exemplary digital recording device, according to an embodiment of the present invention;

FIG. 3 is a simplified schematic block diagram of an exemplary wireless communications hub, according to an embodiment of the present invention;

FIG. 4 is a simplified flowchart illustrating a method of operating a wireless communications hub, according to an embodiment of the present invention;

FIG. 5 is a simplified block diagram of an exemplary wireless hub system including an exemplary wireless communications hub having an Ethernet port, according to an embodiment of the present invention; and

FIG. 6 is a simplified block diagram of an exemplary wireless hub system for communicating with a digital recording device, according to an embodiment of the present invention.

### DESCRIPTION OF EXAMPLE EMBODIMENTS

Embodiments of the present invention relate to a digital device that includes a wireless communications device. Merely by way of example, embodiments of the present invention are applied to a wireless video hub that is configured to communicate with the digital video device using a wireless protocol. However, it would be recognized that embodiments of the invention have a much broader range of applicability. For example, the digital device may comprise a digital video device, a digital recording device, a digital camera, or the like. Similarly, the system may be implemented using any other type of routing device rather than a wireless video hub.

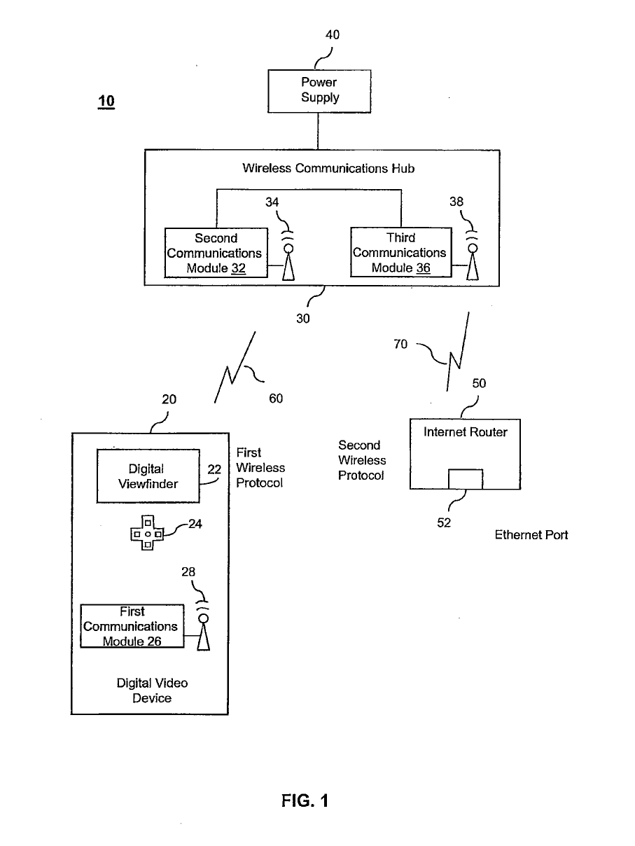

FIG. 1 is a simplified block diagram of an exemplary wireless hub system 10 having a communications hub, such as wireless communications hub 30, in wireless communication with a digital device, such as digital recording device 20 (e.g., a digital camera or digital camcorder). In alternative embodiments, instead of the communications hub comprising wireless communications hub 30, the communications hub may comprise any other type of routing device. The exemplary wireless hub system 10 also includes a router 50 in wireless communication with the wireless communications hub 30, also referred to as a wireless video hub. In an embodiment, the router 50 is an Internet router, although in other embodiments, the router 50 is in direct connection to a computer (e.g., with built in WiFi), an access point, or the like. The wireless communications hub 20 communicates (i.e., receives and transmits signals) with the digital recording device 20 using a first wireless protocol 60 and communicates with the router 50 using a second wireless protocol 70. In some embodiments, the first wireless protocol 60 is different from the second wireless protocol 70. The wireless hub system 10 also includes a power supply 40 coupled to the wireless communications hub 30. In some embodiments, other system components include discrete power supplies as well. Although one wireless communications hub 30, one digital recording device 20, and one router 50 are shown in FIG. 1, any suitable number of these devices and other wireless devices in the wireless communication network may be included in the wireless hub system 10. Although not shown, the router 50 is in communication with the Internet via a service provider.

In the embodiment illustrated in FIG. 1, digital recording device 20 includes a digital viewfinder 22 for displaying output, interface buttons 24 to operate the digital recording device 20, and a first communications module 26 coupled to an antenna 28 for communicating with wireless communications hub 30. Wireless communications hub 30 includes a second communications module 32 coupled to an antenna 34 in order to provide for communications with digital recording device 20 and a third communications module 36 coupled to an antenna 38 and configured to communicate with router 50. The second communications module 32 and third communications module 36 are configured to communicate with each other and other communications modules. Router 50 includes an Ethernet port 52 for connecting to the Internet through a service provider.

Digital recording device 20 may include any suitable hardware, software, firmware, or combination thereof operable to perform functions such as capturing photographic still images in the form of image data, capturing video clips in the form of video data, and recording audio-only input in the form of audio data, storing image data, video data, and audio data as data files, and the like. The digital recording device 20 may also perform the functions of encoding image data, video data, and/or audio data into data packets for transmission according to a first wireless protocol 60, encoding the data packets with information such as an IP (Internet Protocol) address associated with a target device, such as an external server available over the Internet, compressing the data packets, encrypting the data packets, receiving signals from the second communications module 32 according to a first wireless protocol 60, decrypting signals with data packets, sending the data packets to the wireless communications hub 30 according to a first wireless protocol 60, combinations thereof, and the like.

Interface buttons 24 refer to any suitable number and type of interfaces or user input elements that allow a user to input information into digital recording device 20. Some examples of suitable types of interfaces include a power switch, a four position rocker switch with up, down, right, and left indicators, a zoom key, a volume bar, a record button, a pause button, a play button, and the like. Depending on the functionality provided by the digital recording device, other interfaces of user input elements may be utilized.

The digital viewfinder 22 refers to any suitable display for providing visual output. On the digital viewfinder 22, the user can view images in the target area to be captured so that the user can position and focus the digital recording device 20. The user may also use the digital viewfinder 22 to view the scene being captured while the capture is taking place. The images and/or video clips captured by the digital recording device 20 may also be played back and viewed on the digital viewfinder 22. In addition, selections entered using the interface buttons 24 may be displayed on the digital viewfinder 22. For example, the user may use the interface buttons 24 to enter user input such as the selection of a destination location (e.g., archive) to store the data files and the selection can be viewed on the digital viewfinder 22.

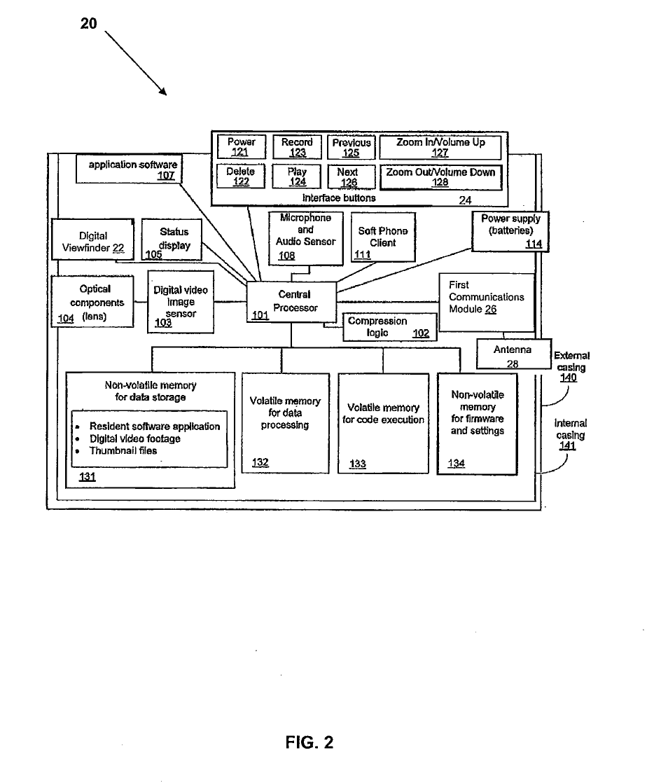

Digital recording device 20 also includes a first communications module 26 coupled to an antenna 28. The first communications module 26 includes a processor (not shown) that performs one or more of the functions of digital recording device 20. For example, the processor may encode the video data files into video data packets to be transmitted according to the parameters defined by the first wireless protocol 60. The processor may also compress the video data packets and send the compressed video packets using antenna 28 to the wireless communications hub 30. In other embodiments, the processor may be provided in another component of digital recording device 20 or may be a central processor 101 (shown in FIG. 2).

Although not shown for purposes of clarity, the digital recording device 20 also includes internal memory. The internal memory stores the still images, audio recordings, and/or video clips captured by the digital recording device 20 as audio data files and/or video data files. The internal memory also stores the executable code for performing the functions of digital recording device 20. In some embodiments, an external memory is provided as an adjunct to or a substitute for the internal memory, for example, in the form of a flash memory card that is insertable into the body of the digital recording device 20. In some embodiments, the memory is a combination memory, with some portions of memory utilized to store firmware and other portions of memory utilized to store audio and/or video content.

The still photographic images and/or video clips captured by digital recording device 20 comprise image data and/or video data that can be stored on digital recording device 20 and/or stored on other devices in the form of audio and/or video data files. Video data includes both audio and visual information from the images and/or video clips. An audio-only recording taken by the digital recording device 20 is audio data that can be stored in the form of an audio data file. Both the video data files and audio data files may be in a digital format. According to embodiments of the present invention, the video data and/or audio data is transmitted wirelessly to other devices in the form of data packets. Data packets may comprise a bundle of data organized in a specific way for transmission and may include any type of data, such as voice, data information, audio, video, other information, or any combination thereof. For example, data packets can be encoded with an IP address of a destination location, the type of data (e.g., video or audio-only), identification information (e.g., time stamp), and other suitable information.

Wireless communications hub 30, also referred to as a wireless video hub 30, may include any suitable hardware, software, firmware, or combination thereof operable to receive and transmit signals (e.g., by using data packets) to wireless devices in wireless hub system 10 according to a first wireless protocol and/or a second wireless protocol. Wireless communications hub 30 can receive signals with data packets from digital recording device 20 using antenna 34 according to a first wireless protocol 60. Wireless communications hub 30 can also transmit signals with data packets to an external server by sending the signals to a router 50 using antenna 38 according to second wireless protocol, which forwards the data to the external server using the Internet. Wireless communications hub 30 can also send signals to digital recording device 20 according to the first wireless protocol 60. In some cases, wireless communications hub 30 may also receive signals from router 50 according to the second wireless protocol 70 using antenna 38. Thus, the wireless video hub provides two way communications to and from the other wireless devices in the system. In one embodiment, wireless communications hub 30 includes logic to determine that the digital recording device 20 (or other wireless device) is within a predetermined range of the wireless communications hub 30 and then signals the digital recording device 20 (or other wireless device) to transmit the data packets to the wireless communications hub 30. This functionality provides for “automatic” uploading of data from the recording device to the hub and potentially to a server, to a computer, or to the Internet. Alternatively, an “on-demand” option can be provided for uploading of content. The predetermined range can be specified in terms of distance (e.g., number of feet) or may be specified based on power budget and/or power conditions. The predetermined range can be impacted by environmental conditions such as interference, power levels, obstacles and obstructions, and the like.

In the illustrated embodiment, wireless communications hub 30 includes a second communications module 32 coupled to an antenna 34 and configured to communicate with digital recording device 20 according to a first wireless protocol 60. Second communications module 32 includes a processor coupled to a computer-readable medium (CRM). In other embodiments, the processor and CRM may be located separately from second communications module 32. The CRM stores code for performing one or more functions of wireless communications hub 30. The processor uses the code to perform the one or more functions. Some examples of code that may be stored on CRM include code for sending signals to the digital recording device 20 using antenna 34, code for processing data packets received from digital recording device 20, and code for forwarding data packets to the third communications module 36. In one embodiment, the CRM can also store code for storing data in a cache in the CRM or other memory in the wireless communications hub 30. In one embodiment, the CRM can also store code for uncompressing the video data packets, encoding data into data packets to be transmitted according to the parameters defined by the first wireless protocol 60, compressing the data packets, transmitting them in a signal to the third communications module 36, and the like.

The illustrated embodiment of wireless communications hub 30 also includes a third communications module 36 coupled to an antenna 38 and configured to communicate with router 50 and/or other devices according to a second wireless protocol 70. Although the term router is utilized herein, the term should be construed as having a broader meaning and can include a computer, a television, a display, or the like. Third communications module 36 includes a processor coupled to a computer-readable medium (CRM). In other embodiments, the processor and CRM may be located separately from third communications module 36. The CRM stores code for performing one or more functions of wireless communications hub 30 and the processor uses the code to perform the one or more functions. Some examples of code that may be stored on CRM of the third communications module 36 include code for receiving the data packets from the second communications module 32, code for encoding information into data packets for transmission according to the second wireless protocol 70, code for transmitting a signal with data packets using antenna 38 to router 50 or other devices according to the second wireless protocol 70, and the like.

In some embodiments, antenna 28 in digital recording device 20 wirelessly receives signals from and transmits signals to the wireless communications hub 30 as radio frequency waves at predetermined frequencies, data rates, and other parameters established by the first wireless protocol 60. Antenna 34 in wireless communications hub 30 receives signals from and transmits signals to the digital recording device 20 based on the parameters established by the first wireless protocol 60. Antenna 38 at wireless communications hub 30 receives signals from and transmits signals to the router 50 based on the parameters established by the second wireless protocol 70.

Wireless protocols 60 and 70 refer to wireless radio communication protocols that define parameters for wirelessly communicating (i.e., receiving and transmitting) signals at radio frequencies. In this illustrated embodiment, signals in the form of data packets are wirelessly communicated between the digital recording device 20 and the wireless communications hub 30 according to a first wireless protocol 60. Signals with data packets are wirelessly communicated between the wireless communications hub 30 and the router 50 according to a second wireless protocol 70. Although data packets are utilized in some embodiments, this is not required by the present invention and other data formats may be utilized in other embodiments.

Wireless communication protocols 60 and 70 can have any suitable parameters. Some examples of suitable parameters include one or more frequencies, a range of frequencies, a data rate, a data rate range, a buffer rate, a buffer rate range, and a power range. In some cases, communication protocols 60 and 70 may define a range of data rates for communicating signals. In some embodiments, the first wireless protocol 60 is different from the second wireless protocol 70. In other embodiments, the first wireless protocol 60 may be the same as the second wireless protocol 70.

According to some embodiments, the first wireless protocol 60 is characterized by a low power in comparison to the second wireless protocol 70. The user of a low power protocol to transmit data from the digital recording device 20 to the wireless communications hub 30 provides for enhanced battery life in the digital recording device 20. Additionally, the use of a low power protocol enables the use of lower cost system components, thereby reducing the overall cost of the digital recording device 20.

Embodiments of the invention enable extended video transfer operations by constraining the range and operation of the digital recording device 20. In some embodiments, the data being transferred from the digital recording device 20 to the wireless communications hub 30 includes audio data and/or video data. Accordingly, the data stream can be optimized for this specific type of data. In contrast, a conventional hand-held device, such as a smart phone, sends a variety of data across a network (such as text messages, web surfing traffic, and other random data exchanges). By optimizing the transmission and reception receivers for only the type of content being transmitted from the digital recording device 20, efficiency can be improved.

Further, embodiments of the invention can be utilized in close proximity to the wireless connection hub 30. Typical wireless protocols attempt to extend the range of a wireless network to as large a distance as possible. Thus, extending the range of the wireless network requires substantial power, particularly when the distance is large. In contrast with these conventional approaches, embodiments of the present invention restrict the range of the first wireless protocol to a distance optimized for extending the battery use of the digital recording device 20. For example, one embodiment allows for transfer of video data when the camcorder is within 30 feet of the wireless communications hub 30. Even if the devices could communicate at a distance further than the predefined distance, no communication would occur at greater distances in this embodiment in order to conserve battery life. In some embodiments, if a greater range is desired, then a greater number of wireless hubs could be located at appropriately spaced apart distances. In this fashion, a mesh or net could be created to allow for video transfer from the digital recording device 20 while still optimizing battery life.

Further still, in some embodiments, because the first wireless communication protocol 60 is used for the transfer of specific type of data, the properties of the first wireless communication protocol 60 can be configured to match the specific type of data. For example, a streaming video feed from the digital recording device 20 may be transmitted at 150 kbps. Therefore, the first wireless transmission protocol 60 may include a maximum transfer rate of 150 kbps, and may be capped at this speed or otherwise be restricted to this speed by the nature of the technology. This implementation is contrary to conventional wireless networks, since conventional wireless networks are generally configured to allow for maximum data transfer speeds between devices. WiFi connections, for example, increase the data transfer speed as the transmitter and receiver get closer to one another. This would not take place in an embodiment of the present invention. Again, in some embodiments, the data transfer speed may be consistent regardless of the distance or potential bandwidth available in order to maximize battery life. Furthermore, the power output of the digital recording device 20 can be dynamically adjusted based on the distance from the wireless communications hub 30. Thus, the transmission power would be decreased when the digital recording device 20 is near the wireless communications hub 30 in order to minimize power consumption.

Further, in some embodiments, the data may be optimized to minimize the power requirements of the digital recording device 20. This may mean that more or less data processing is performed within the digital recording device 20 in order to reduce the total power requirements of capturing the video and transmitting it to the wireless communications hub 30. For example, if the power budget required to compress data and then transmit the compressed data is higher than the power budget required to transfer uncompressed data (with no or little compression), then the lowest total power configuration may be used. Accordingly, embodiments of the invention provide a dynamic system where the digital recording device 20 keeps track of its distance from the wireless communications hub 30, and continually evaluates the lowest power budget method for delivering content.

Additionally, the first wireless protocol 60 provides transmission rates suitable for the real-time transfer of video data from the digital recording device 20 to the wireless communications hub 30. Because of the high data density associated with video data, low bandwidth protocols are generally unsuitable for use in transferring video data in real-time.

First wireless protocol 60 and second wireless protocol 70 can also be of any suitable type. For example, the first wireless protocol 60 can be a certified wireless USB providing a short-range, high-bandwidth, and wireless radio communication protocol. First wireless protocol 60 and second wireless protocol 70 can also include any suitable standard. For example, second wireless protocol 70 can include an 802.11-based standard.

Router 50 may include software, firmware, hardware or combination thereof for performing its functions. For example, the router 50 may include processors, network interfaces, and memory such as random access memory (RAM), non-volatile random access memory (NVRAM), flash memory, or any other type of memory. General functions performed by the router 50 include routing data packets to IP addresses of devices over the Internet, such as an external server, prioritizing and scheduling the communication of data, processing the data for communication, and performing firewall functions, among others. More specifically, router 50 wirelessly receives signals with data packets (e.g., video data packets) from the wireless communications hub 30 according to the second wireless protocol 70. The data packets can be encoded with an IP address of an external server or other device. Router 50 wirelessly forwards the data packets in a signal to the external server/device on the Internet and/or other communication networks. Some examples of other communication networks may include a public switched telephone network (PSTN), a public or private data network, a local area network (LAN), a wireless local area network (WLAN), a wide area network (WAN), a Metropolitan area network (MAN), a global computer network such as the Internet, a wireline or wireless network, a local, regional, or global communication network, an enterprise intranet, other suitable communication link, or any combination of the preceding.

In the illustrated embodiment, router 50 includes an Ethernet port 52 for coupling an Ethernet cable to an Internet service provided by a service provider. In other embodiments, router 50 may include additional Ethernet ports and/or other types of ports. Although not shown, the router 50 also includes an antenna for wirelessly receiving the signals with data packets from the wireless communications hub 30 according to the second wireless protocol 70.

In one embodiment, a user selects a destination location (e.g., device and/or folder) where the user desires data captured using the digital recording device 20 to be stored externally. The user may input information into the digital recording device 20 or other device that identifies the location. For example, the digital recording device 20 may allow the user to browse a list of pre-defined locations and select from the list. Information related to the external storage location may be input using a computer and then transmitted to the digital recording device 20 through the wireless communications hub 30. In some embodiments, the IP address and other location information associated with the selected destination location may be encoded into the data packets either by the digital recording device 20 or by the wireless communications hub 30. When the router 50 receives the signal with the data packets, the router 50 determines the IP address encoded into the data packets, and routes the data packets in a signal to the destination location corresponding to the IP address. The data is then stored in one or more memories at the destination location so that the data (video and/or audio) can be played at the destination location.

Modifications, additions, or omissions may be made to wireless hub system 10 without departing from the scope of embodiments of the present invention. The components of wireless hub system 10 may be integrated or separated according to particular needs. For example, the router 50 may be integrated into the wireless communications hub 30. In this example, third communications module 36 can communicate the signals with data packets directly to the external server of the Internet or to a wireless device available over the communication network of wireless communications hub system 10. Moreover, the operations of wireless hub system 10 may be performed by more, fewer, or other system modules. Additionally, operations of wireless hub system 10 may be performed using any suitable logic comprising software, hardware, other logic, or any suitable combination of the preceding. In communicating data from the wireless communications hub 30 to a server, the term server is intended to include a processing and storage device suitable for handling video data. In one embodiment, the server comprises a personal computer, but embodiments of the present invention are not limited to this device and may include notebook computers, media hubs, dedicated servers, internet servers, mobile devices, mobile phones, PDA, and the like.

FIG. 2 is a simplified schematic block diagram of an exemplary digital recording device 20, according to an embodiment of the present invention. Digital recording device 20 includes an external casing 140 and an internal casing 141 for enclosing the internal components of the digital recording device 20. Some of the components are located within the internal casing 141, some are located within both the external casing 140 and an internal casing 141, some component are located outside the external casing 140 and within both the external casing 140 and an internal casing 141.

Digital recording device 20 also includes a central processor 101 (e.g., a microprocessor or an application-specific integrated circuit (ASIC)) that performs the functions of digital recording device 20. The central processor 101 is coupled to a digital video image sensor 103, optical components (e.g., a lens) 104, a status display 105, a digital viewfinder 22, and interface buttons 24. The interface buttons 24 include a power button 121, a delete button 122, a record button 123, a play button 124, a previous button 125, a next button 126, a zoom in/volume up button 127, and a zoom out/volume down button 128. Digital recording device 20 also includes an application software 107, a microphone, an audio sensor 108, a soft phone client 111, a power supply (e.g., rechargeable batteries) 114, a first communications module 26 coupled to an antenna 28, and compression logic 102, coupled to the central processor 101.

Digital recording device 20 also includes memory coupled to the central processor 101. In one embodiment, the memory includes internal and/or removable non-volatile memory for data storage 131 to store the video data files, internal volatile memory for data processing 132, internal volatile memory for code execution and temporary video content capture 133, and internal non-volatile memory for firmware and settings 134. An example of an internal volatile memory for code execution and temporary video content capture 133 includes synchronous dynamic random access memory (SDRAM).

The digital video image sensor 103 and the optical components (e.g., lens) 104 capture visual data of still images and/or video clips comprising a sequence of photos and/or frames over a period of time. Some examples of digital video image sensors 103 include a 1280×1024 pixel complementary metal oxide semiconductor (CMOS) sensor or a charged coupled device (CCD). The microphone and audio sensor 108 capture audio (e.g., sound) data corresponding to the captured images and/or video clips. The microphone and audio sensor 108 can also capture sound of a call for transmittal over voice over Internet Protocol (VoIP).

Status display 105 displays information such as status, remaining recording time, battery level, low lighting conditions, and other suitable status information. Status display 105 may include a liquid crystal display (LCD).

Application software 107 uses internal and/or removable non-volatile memory 131 to store video data captured by digital video image sensor 103 and audio data recorded by the microphone and audio sensor 108. In one embodiment, application software 107 includes code configured to cause video data packets to be transmitted wirelessly to wireless communications hub 30 and then to a server of a communication system (e.g., an instant messaging communication system) on the Internet via router 50 connected to the Internet or to another device connected to the Internet (e.g., a computer). Although the term server is used herein, embodiments of the present invention are not limited by this term. As persons having ordinary skill in the art would understand, other communications systems are also included within the scope of embodiments of the present invention. The associated video data files can also be recorded at the same time locally in the internal and/or removable non-volatile memory for data storage 131 within the digital recording device 20. For example, the application software 107 may provide the user the option of saving the captured video data file to the digital recording device 20 or sending the captured video data file to the wireless communications hub 30 for transmission to other devices using the Internet.

Central processor 101 refers to any suitable device for performing one or more of the functions of the digital recording device 20. In one embodiment, central processor 101 may execute the application software 107, the instructions of soft phone client application II, compression logic 102, and/or other code stored in memory on digital recording device 20. Some other code may include code for converting the video data into a video data file having a video file format such as Moving Picture Experts Group (MPEG), or Motion Joint Photographic Experts Group (M-JPEG), and code for allowing the user to make VoIP calls using their digital recording device 20, among others.

The first communications module 26 facilitates communications between the digital recording device 20 and the wireless communications hub 30. The first communications module 26 encodes the video data into video data packets according to the first wireless protocol 60. In one embodiment, the first communications module 26 encodes the audio-only data into audio data packets according to the first wireless protocol 60. The data packets are compressed by the central processor 101 or by the first communication module 26 using compression logic 102.

Although FIG. 2 shows a number of components, digital recording device 20, according to embodiments of the invention, may comprise any suitable combination or subset of such components.

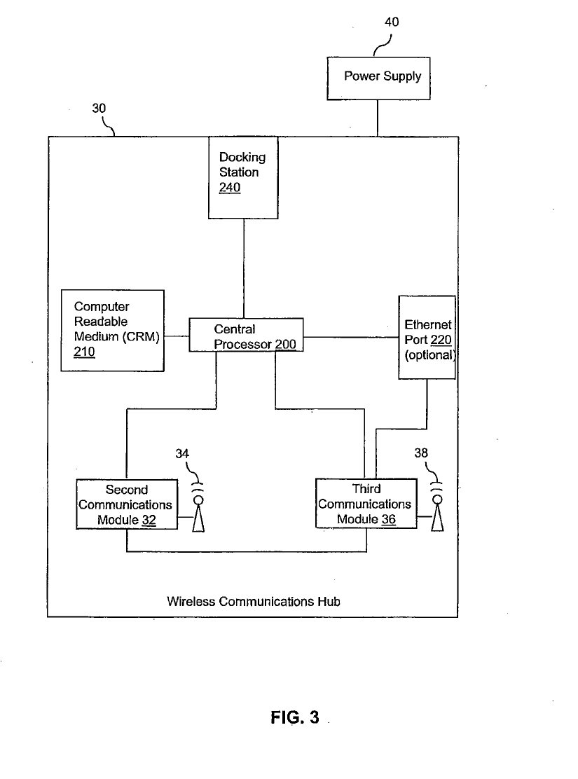

FIG. 3 is a simplified schematic block diagram of an exemplary wireless communications hub, according to an embodiment of the present invention. In the illustrated embodiment, wireless communications hub 30 includes a central processor 200 coupled to a computer-readable medium 210, a second communications module 32, a third communications module 36, an Ethernet port 220 for connecting an Ethernet cable, and a docking station 240 for docking the digital recording device 20 in a docking position. Second communications module 32 is communicatively coupled to third communications module 36. Third communications module 36 is also coupled to Ethernet port 220. Wireless communications hub 30 is coupled to a power supply 40.

Central processor 200 refers to any suitable processor for performing one or more of the functions of wireless communications hub 30. Some examples of suitable processors include a microprocessor or an application-specific integrated circuit (ASIC). Central processor 200 uses code stored on computer-readable medium 210 to perform the functions of wireless communication hub 30. Although wireless communications hub 30 shows the central processor 200, the wireless communications hub 30 may include additional processors. For example, some of the functions of wireless communications hub 30 can be performed by one or more processors located in second communications module 32 or in third communications module 36.

Computer-readable medium (CRM) 210 can be a memory that stores data and may be in any suitable form and type including a memory chip, and the like. Some suitable types of memory include volatile memory such as synchronous dynamic random access memory (SDRAM), dynamic random access memory (DRAM), and non-volatile memory such as flash memory and write-once memory. The CRM 210 can store code for determining that digital recording device 20 or other device in system 10 is within a predetermined range of the wireless communications hub 30, code for determining the IP address of the destination device encoded in the data packets received from digital recording device 20, code for sending the data packets from the second communications module 32 to the third communications module 36, code for communicating data through Ethernet port 220 to and from a server computer on the Internet or the router 50, code for compressing and uncompressing, or otherwise processing data and data packets, and other suitable code for facilitating the communicating data packets and data files to the wireless devices in wireless communications hub system 10 and in other communication systems. The CRM 210 can also include code for streaming video data packets from digital recording device 20 to an external server or to a wireless device in wireless hub system 10. The CRM 210 can include a cache. In some embodiments, the data received from digital recording device 20 is temporarily stored in the cache and then subsequently transmitted to a server or other wireless device such as router 50. In other embodiments, the data stored in the cache is downloaded using a wired connection to the wireless hub. Although wireless communications hub 30 in FIG. 3 shows only one CRM 210, wireless communications hub 30 may include one or more additional CRMs. For example, second communications module 32 and third communications module 36 may include computer-readable medium.

Second communications module 32 may comprise any suitable hardware, software, firmware, or combination thereof operable to facilitate communications between the wireless communications hub 30 and the digital recording device 20 or other wireless devices in wireless hub system 10 according to the first wireless protocol 60 (shown in FIG. 1). Second communications module 32 may comprise a processor and a CRM coupled to the processor. The processor may use code stored on the CRM. The CRM can include code for wirelessly communicating signals with data packets to and from digital recording device 20 and other wireless devices according to the first wireless protocol 60 using antenna 34. The CRM can also include code for communicating with third communications module 36. The CRM can also include code for transmitting signals to digital recording device 20 (or other wireless devices) indicating that the digital recording device 20 is within a predetermined range of the wireless communications hub 30.

Antenna 34 is coupled to second communications module 32 and configured to transmit and receive wireless radio frequency signals according to the first wireless protocol 60. In other embodiments, antenna 34 can communicate wireless radio frequency signals according to another protocol.

Third communications module 36 may comprise any suitable hardware, software, firmware, or combination thereof operable to facilitate communications between the wireless communications hub 30 and the router 50. Third communications module 36 may comprise a processor and a CRM coupled to the processor. The processor may use code stored on the CRM. The CRM may include code for receiving signals with data packets from and transmitting signals with data packets to router 50 (or other wireless devices) according to the second wireless protocol 70 using antenna 38. The CRM can also include code for communicating data through Ethernet port 220 to router 50 and then to a server computer on the Internet. The CRM can also include code for communicating data through Ethernet port 220 directly to the server computer on the Internet which includes code for establishing a communication link to the Internet service provider.

Antenna 38 is coupled third communications module 36 to transmit and receive wireless radio frequency signals according to the second wireless protocol 70. In other embodiments, antenna 38 can communicate wireless radio frequency signals according to another protocol. Although FIG. 3 illustrates separate antennas 34 and 38 coupled to the communications modules, this is not required by embodiments of the present invention. In other embodiments, a single antenna is utilized in the wireless communications hub. In some embodiment, the choice of the wireless communications protocols to utilize can be determined by a driver in the antenna design process, resulting in the use of a single antenna or multiple antennas.

Docking station 240 can include any suitable socket and/or other connecting components that facilitate receiving and maintaining the digital recording device 20 in a docking position in which the digital recording device 20 is engaged with the docking station 240. For example, docking station 240 can be a Universal serial bus (USB) port. Docking station 240 can have any number of functions such as allowing the charging of the power supply 114 (shown in FIG. 2) of the digital recording device 20. In addition to recharging of the batteries of the recording device, the docking station can be used to communicate signals including data between the digital recording device 20 and the wireless communications hub 30. Thus, although embodiments of the present invention provide for wireless communications between the recording device and the wireless hub, a wired communications capability is also provided in the embodiment illustrated in FIG. 3.

Power supply 40 refers to any suitable device for supplying power for the components within wireless communications hub 30. In some cases, power supply 40 can also power components within a device coupled to the docking station 240 in a docking position. For example, power supply 40 can power components within digital recording device 20 which includes charging (or recharging) the power supply 114 of digital recording device 20 while digital recording device 20 is in the docking position in docking station 240. Power supply 40 may include a battery, fuel cell, single use or rechargeable direct current (DC) power source, or may be an external current (AC) source, or some other suitable source such as a USB connection.

Wireless communications hub 30 also includes an Ethernet port 220 for connecting an Ethernet cable to router 50 or directly to a communication line to a service provider of the Internet (e.g., telecommunications company). An Ethernet port 220 provides the user the option of establishing an Ethernet connection that can provide a higher transmission rate than a wireless Internet connection. In some embodiments, wireless communications hub 30 may not have an Ethernet port depending on the particular system design.

Although the wireless communications hub 30 shows one docking station 240 and one Ethernet port 220, other embodiments of wireless communications hub 30 can have any number or type of port for connecting to any suitable type of device or service. For example, wireless communications hub 30 can include a video output port for communicating video data to a monitor such as a TV monitor or a computer monitor. The user can use a connector to couple the video output port on the wireless communications hub 30 to the monitor to play the images and footage from the digital recording device 20. The user can, for example, select the play button 124 on the digital recording device 20 and content may play on the monitor and/or the content may be displayed on the digital viewfinder 22.

Embodiments of the present invention are directed to wireless communications hubs, systems having wireless communications hubs in communication with digital recording devices, and methods of operating wireless communications hubs. As described throughout, a user may capture still images and/or video clips (i.e., video data) using a digital recording device. In one embodiment, when the user wants to wirelessly upload the video data, the user brings the digital recording device within a reception range of the wireless communications hub. The digital recording device then transmits the video data to the wireless communications hub using a low-power wireless protocol with a high transmission rate. The wireless communications hub receives the video data and may then forward the video data to a wireless router using a second wireless protocol which has higher power and a lower or higher transmission rate. In a specific embodiment, the wireless router forwards the video data through the Internet to a location selected by the user. For example, the user may choose to forward the video data to a website server, which can make the still images and/or video clips available on a video file sharing website.

In some embodiments, once the digital recording device is within range, the wireless communications hub sends a signal to the digital recording device indicating that the recording device is within range. In response, the recording device transmits the video data to the wireless communications hub. This particular implementation is not required by embodiments of the present invention and other data flows may be utilized in other embodiments. One of ordinary skill in the art would recognize many variations, modifications, and alternatives.

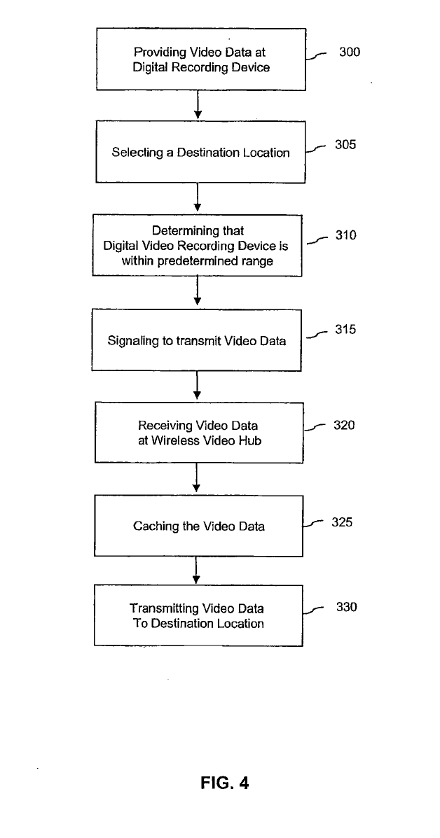

FIG. 4 is a simplified flowchart illustrating a method of operating a wireless communications hub 30, according to an embodiment of the present invention. The method begins by providing video data at the digital recording device 20 (300). The user could use the optical components 104, digital video image sensor 103, and microphone and audio sensor 108 to capture photographic images and/or video clips to provide video data. In other embodiments, the user could download video data from another source such as a computer in order to provide video data. The video data can be stored in the digital recording device 20 as video data files in non-volatile memory 131.

The user can select a destination location (e.g., an external server) for storing the video data externally (305). The user can select the destination location on the digital recording device 20 or other device. For example, the user can use the interface buttons 24 on the digital recording device 20 to input a name of a video sharing website or a name of a computer on the wireless local area network associated with the wireless communications hub system 10. In some cases, the user may also provide a login username and/or password. The central processor 101 of the digital recording device 20 can, in conjunction with a router, determine the IP address of the external server corresponding to the video sharing website or determine the IP address of the computer corresponding to the input name of the computer.

The digital recording device 20 can be placed within a predetermined range of the wireless communications hub 30. The predetermined range can be any suitable distance. For example, the predetermined range can vary from between 30 to 1000 feet. The predetermined range can be set by the user in some embodiments. For example, the user may set the predetermined range to be the furthest distance from the wireless communications hub 30 that is within the boundaries of their home, office, or other suitable area.

The central processor 200 or a processor in the second communications module 32 determines that the physical location of the digital recording device 20 is within a predetermined range of the wireless communications hub 30 (310). If the central processor 200 or a processor in the second communications module 32 determines that the digital recording device 20 is within the predetermined range, then the second communications module 32 of wireless communications hub 30 uses antenna 34 to send a signal to digital recording device 20 to transmit the video data packets (315).

In one embodiment, the second communications module 32 using the antenna 34 may broadcast periodic or continuous signals that can be received by antenna 28 when the physical location of the digital recording device 20 is within a predetermined range or distance (e.g., 30 feet) of the wireless communications hub 30. The signals trigger the transmission of video data packets. When digital recording device 20 is within the predetermined range, the digital recording device 20 receives the signal to transmit the video data packets. In response, the digital recording device 20 sends the signal with the video data packets. One of ordinary skill in the art would recognize many variations, modifications, and alternatives.

In another embodiment, the user may attempt to connect the digital recording device 20 to the wireless communications hub 30 by sending an initiation signal from the digital recording device 20 to the wireless communications hub 30. In this embodiment, first communications module 26 using antenna 28 may broadcast periodic or continuous signals associated with a predetermine range or distance. The signal can be received by antenna 34 when the physical location of the digital recording device 20 is within the predetermined range or distance of wireless communications hub 30. When the signal is received by antenna 34, the second communications module 32 determines that the digital recording device 20 is within the predetermined range. In response, antenna 34 transmits a signal to digital recording device 20 to send video data packets and digital recording device 20 sends the video data packets.

In yet another embodiment, first communications module 26 using antenna 28 may broadcast periodic or continuous signals at a preset power level according to a first wireless protocol 60. When the signal is received by antenna 34, the signal is processed by second communications module 32 to determine the signal strength, determine the physical location of the digital recording device 20 based on the signal strength and the present power level, and determine whether the physical location of the digital recording device 20 is within the predetermined range. If the digital recording device 20 is within the predetermined range, the antenna 34 transmits a signal to digital recording device 20 to send video data packets and the digital recording device 20 sends signals with the video data packets.

In another embodiment, the user enters an indication to start transmitting video data packets on the digital recording device 20. For example, the user may push an interface button 24 that indicates to initiate transmission. In response, the digital recording device 20 sends a signal with the video data packets to the wireless communications hub 30. The wireless communications hub 30 determines that the digital recording device 20 is within the predetermined range when it receives the signal with the video data packets.

In another embodiment, the user enters an indication to start transmitting video data packets on wireless communications hub 30. The wireless communications hub 30 determines that the digital recording device 20 is within the predetermined range when it receives the indication. In response, second communications module 34 uses antenna 34 to transmit a signal to digital recording device 20 to send video data packets and digital recording device 20 sends the video data packets.

Once the digital recording device 20 receives the signal from wireless communications hub 30 to send video data packets, the digital recording device 20 sends the video data packets to wireless communications hub 30 using antenna 28. The video data packets are encoded by the digital recording device 20 for transmittal according to the first wireless protocol 60. The video data packets are also encoded with other information such as the IP address of the destination location selected by the user. In some cases, the video data packets may also be compressed. The wireless communications hub 30 receives the video data packets transmitted from the recording device using antenna 34 (320).

In one embodiment, the video data packets are stored temporarily in a cache in the computer-readable medium 210 of wireless communications hub 30 (325). In other embodiments, the video data packets are not stored in the cache. The wireless communications hub 30 encodes the video data into video data packets that can be transmitted according to the second wireless protocol 70. In some cases, the wireless communications hub 30 may uncompress the video data packets received from digital recording device 20, encode the video data into video data packets that can be transmitted according to the second wireless protocol 70, and the compress the video data packets for transmittal. In some embodiments, the video data received from the digital recording device may be processed at the wireless video hub prior to or after caching or prior to transmission from the video hub to a destination location such as a server or a router. The processing may include data compression, video processing, or the like.

The video data packets are transmitted to the destination location (330). The video data packets are transmitted to the router 50 using antenna 38 and the router 50 forwards the video data packets to the destination location indicated by the IP address encoded into the video data packets. The destination location can be any suitable location, such as an external server using the Internet, a wireless device on the wireless network associated with the wireless communications hub system 10 (e.g., a computer), a device available over another communication network (e.g., a cell phone available over a cell network).

In some embodiments, video data is streamed from the digital recording device 20 to a computer or server using the wireless communications hub 30. This embodiment provides for virtually unlimited “storage” on the digital recording device 20, limited by the size of the storage media present on the computer or server, which is typically much larger than that available on portable devices. Referring to FIG. 4, video data captured by the recording device (300) is transmitted to the wireless hub (320) and then transmitted in real time to the destination location (330). Other than some potential buffering at one or more of the devices, the video data is effectively stored only at the destination location, thereby providing a nearly unlimited virtual memory to the recording device.

It should be appreciated that the specific steps illustrated in FIG. 4 provide a particular method of operating a wireless communications hub, according to an embodiment of the present invention. Other sequences of steps may also be performed according to alternative embodiments. For example, alternative embodiments of the present invention may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular embodiments. For example, the step of caching the video data may be optional in some embodiments. One of ordinary skill in the art would recognize many variations, modifications, and alternatives.

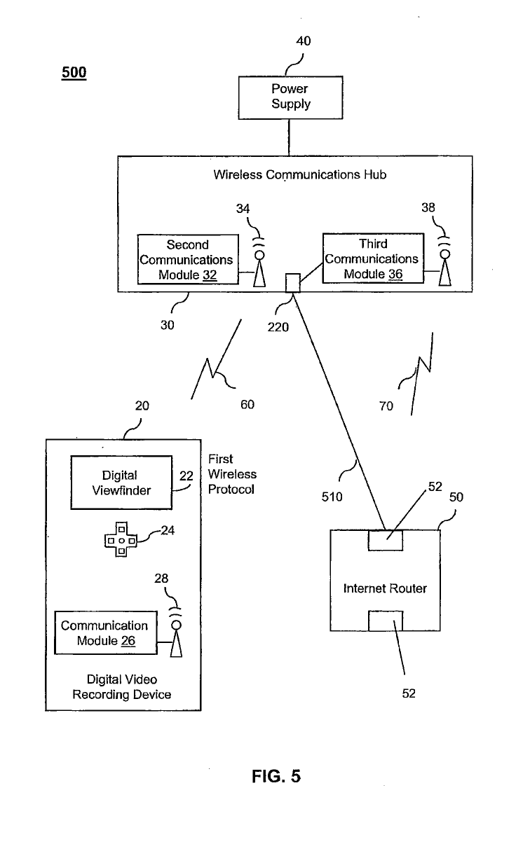

FIG. 5 is a simplified block diagram of an exemplary wireless hub system 500 including a wireless communications hub 30 having an Ethernet port 220 according to an embodiment of the present invention. In the illustrated embodiment, the wireless hub system 500 has a digital recording device 20 in wireless communication with the wireless communications hub 30 according to a first wireless protocol 60. The wireless communications hub 30 communicates with the router 50 through an Ethernet connection. The wireless hub system 500 also includes a power supply 40 coupled to the wireless communications hub 20. Although one wireless communications hub 30, one digital recording device 20, and one router 50 are shown, any suitable number of these devices and other wireless devices in the wireless communication network may be included in the wireless hub system 500. Although not shown, the router 50 is in communication with the Internet via a service provider.

Digital recording device 20 includes a digital viewfinder 22, interface buttons 24, and a first communications module 26, and an antenna 28 coupled to the first communications module 26 for communicating with wireless communications hub 30 according to a first wireless protocol 60. Wireless communications hub 30 includes a second communications module 32 coupled to an antenna 34 for communicating with digital recording device 20 according to the first wireless protocol 60. The wireless communications hub 30 also includes a third communications module 36 coupled to an antenna 38 for communicating with router 50 according to the second wireless protocol 70. Wireless communications hub 30 also has an Ethernet port 220 for connecting an Ethernet cable to connect to the Ethernet port 50 of router 50. Wireless communications hub 30 also has another Ethernet port 220 for connecting an Ethernet cable to connect to the Internet service through the service provider.

In the illustrated embodiment, the user has the option of coupling the router 50 to the wireless communications hub 30 using an Ethernet cable connection or using a wireless communication link according to the second wireless protocol 70.

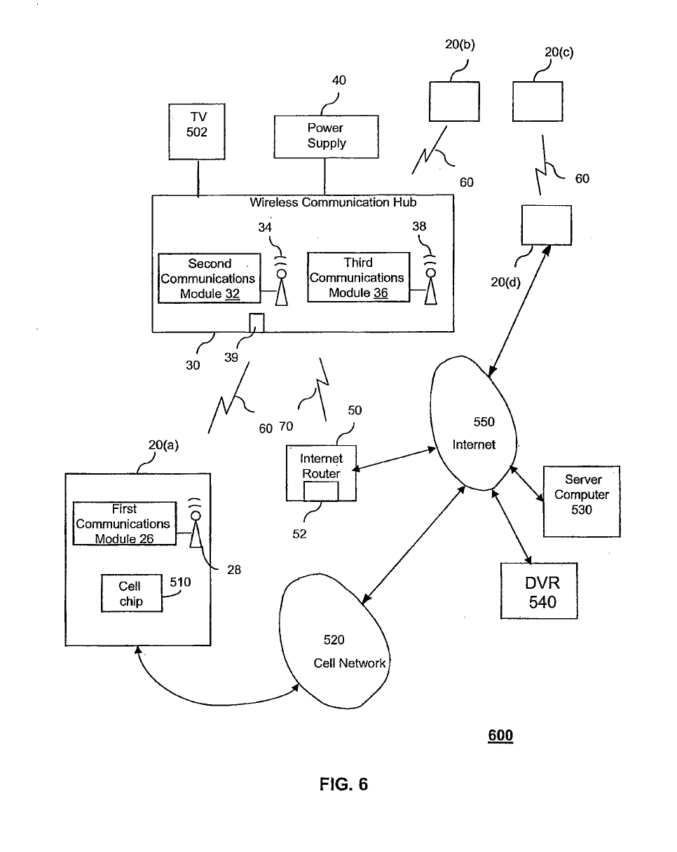

FIG. 6 is a simplified block diagram of another exemplary wireless hub system 510, according to an embodiment of the present invention. Wireless hub system 510 includes four digital recording devices 20(a), 20(b), 20(c), and 20(d). Wireless hub system 510 also has a wireless communications hub 30 coupled to a power supply 40 and coupled to a TV 502. The wireless communications hub 20 sends signals to and receives signals from digital recording devices 20(a), 20(b), 20(c), and 20(d) according to a first wireless protocol 60. The digital recording devices 20(a), 20(b), 20(c), and 20(d) can also send signals to each other according to the first wireless protocol 60. Wireless hub system 510 also includes a router 50 having an Ethernet port 52. The router 50 is in communication with the Internet 550 which is in communication with the digital recording device 20(d), server computer 530, digital video recorder (DVR) 540, and the cell network 520. The cell network is also in communication with the digital recording device 20(a).

Digital recording device 20(a) includes a first communications module 26, an antenna 28 coupled to the first communications module 26, and a cell chip 510. Although not shown, the other three instances of the digital recording device 20(b), 20(c), and 20(d) also have a first communications module 26, an antenna 28 coupled to the first communications module 26, and a cell chip 510. The cell chip 510 in the digital recording device 20(a) is configured to communicate a signal with data from the digital recording device 20(a) through the cell network 520 according to a cell protocol. The signal can be forwarded through the Internet 550 to server computer 530 or DVR 540. In this embodiment, the first communications module 26 may have code stored on a CRM encoding audio data to be in compliance with a cell phone protocol for transmitting audio data over the cell phone network 520.

Wireless communications hub 30 includes a second communications module 32 coupled to an antenna 34 to communicate with digital recording device 20 and a third communications module 36 coupled to an antenna 38 to communicate with router 50. The second communications module 32 and third communications module 36 are communicatively coupled to together. Wireless communications hub 30 also includes an Ethernet port 39.

The first communications module 26 of the digital recording device 20(a) can communicate signals to the wireless communications hub 30 using antenna 28 according to a first wireless protocol 60. For example, first communications module 26 can use antenna 28 to transmit a signal with video data packets according to a first wireless protocol 60 to wireless communications hub 30. Wireless communications hub 30 can receive the signal at antenna 34. The wireless communications hub 30 can encode the data packets for transmission according to the second wireless protocol 70. Wireless communications hub 20 sends signals to and receives signals from the router 50 wirelessly according to a second wireless protocol 70 or through an Ethernet connection between Ethernet port 39 and Ethernet port 52. The third communications module 38 uses antenna 38 to transmit a signal with data packets to the server computer 530 or DVR 540 through the router 50. The wireless communications hub 30 can also forward the data packets to the TV 502 so that the images or video clips can be viewed on the TV 502. In various embodiments, one or more of digital recording devices 20(a)-20(d) may comprise a Flip Video Camcorder provided by Pure Digital Technologies, Inc., and the DVR 540 may comprise a TiVo DVR provided by TiVo Inc.

It should be understood that embodiments of the present disclosure, as described above, may be implemented in the form of control logic using computer software in a modular or integrated manner. Based on the disclosure and teachings provided herein, a person of ordinary skill in the art will know and appreciate other ways and/or techniques to implement the present disclosure using hardware and/or a combination of hardware and/or software.

Any of the software components or functions described in this application, may be implemented as software code to be executed by a processor using any suitable computer language such as, for example, Java, C++, or Perl using, for example, conventional or object-oriented techniques. The software code may be stored as a series of instructions, or commands on a computer-readable medium. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention.

A recitation of “a”, “an” or “the” is intended to mean “one or more” unless specifically indicated to the contrary.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

What is claimed is:

1. A method comprising:
determining that a physical location of a digital device is within a predetermined range of a communications hub that is less than a maximum operable range of the communications hub;
receiving first video data from the digital device in accordance with a first communications protocol; and
transmitting second video data to a computing device in accordance with a second communications protocol.

2. The method of claim 1, wherein the step of determining that the physical location of the digital device is within the predetermined range comprises:
broadcasting a signal that is capable of being received by the digital device when the physical location of the digital device is within the predetermined range; and
receiving a response signal from the digital device.

3. The method of claim 1, wherein the first communications protocol is characterized by a low power usage relative to the second communications protocol.

4. The method of claim 1, wherein the first video data is transmitted from the digital device automatically when the digital device is within the predetermined range of the communications hub.

5. The method of claim 1, wherein the predetermined range is set by a user.

6. The method of claim 1, wherein the transmission power of the digital device is dynamically adjusted based on the distance between the digital device and the communications hub.

7. The method of claim 1, wherein the transmission of the second video data to the computing device is based on a destination location designated by a user input into the digital device, wherein the destination location comprises at least one of an IP address and a folder associated with the computing device.

8. A communications hub, comprising:
a processor configured to determine that a physical location of a digital device is within a predetermined range of the communications hub; and
a set of communications modules configured to:
receive first video data that is transmitted from the digital device to the communications hub in accordance with a first communications protocol, and
transmit second video data from the communications hub to a computing device in accordance with a second communications protocol.

9. The communications hub of claim 8, wherein a first communications module included in the set of communications modules is configured to perform the step of receiving the first video data that is transmitted from the digital device to the communications hub.

10. The communications hub of claim 9, wherein a second communications module included in the set of communications modules is configured to perform the step of transmitting the second video data from the communications hub to the computing device.

11. The communications hub of claim 8, further comprising a docking station configured to charge the digital device when the digital device is coupled to the docking station.

12. The communications hub of claim 8, wherein the first communications protocol comprises a certified wireless Universal Serial Bus (USB) protocol, and the second communications protocol comprises an 802.11-based protocol.

13. The communications hub of claim 8, wherein the computing device comprises at least one of a personal computer, a television, a video monitor, a router, a server associated with a media sharing website, and a server not associated with a media sharing website.

14. The communications hub of claim 8, wherein the digital device comprises a digital video camera.

15. The communications hub of claim 8, wherein the received first video data is compressed, and the processor is further configured to:
uncompress the first video data to generate first uncompressed video data;
encode the first uncompressed video data into one or more packets that can be transmitted in accordance with the second communications protocol; and
compress the one or more packets for transmission to the computing device.

16. The communications hub of claim 15, wherein the step of encoding comprises associating the one or more packets with an Internet Protocol (IP) address associated with the computing device.

17. The communications hub of claim 15, wherein the one or more packets comprise data that is optimized for a single data type.

18. A digital device, comprising:
a memory unit storing first video data;
a processing module configured to receive a user input specifying a destination location for the first video data that is associated with a computing device; and
a transmitting device configured to transmit the first video data to a communications hub in accordance with a first communications protocol to allow the first video data to then be transmitted to the destination location for storage on the computing device in accordance with a second communications protocol.

19. The digital device of claim 18, wherein the processing module is further configured to receive a signal from a communications hub indicating that a physical location of the digital device is within a predetermined range of the communications hub.

20. The digital device of claim 18, wherein the transmitting device is configured to transmit an initiation signal to the communications hub, and wherein the communications hub is configured to determine that a physical location of the digital device is within a predetermined range of the communications hub based on the initiation signal.

21. The digital device of claim 18, wherein the first video data is transmitted from the digital device to the communications hub based on a user command.
